(19) United States
(12) Patent Application Publication
(10) Pub. No.: US 2015/0261374 A1
(43) Pub. Date: Sep. 17, 2015

(54) COORDINATE INPUT DEVICE AND DISPLAY DEVICE PROVIDED WITH SAME

(71) Applicant: SHARP KABUSHIKI KAISHA, Osaka-shi, Osaka (JP)

(72) Inventors: Makoto Eguchi, Osaka (JP); Shinya Yamasaki, Osaka (JP); Misa Kubota, Osaka (JP)

(73) Assignee: Sharp Kabushiki Kaisha, Osaka (JP)

(21) Appl. No.: 14/434,955

(22) PCT Filed: Oct. 18, 2013
(86) PCT No.: PCT/JP2013/078276

§ 371 Date: Apr. 10, 2015

(30) Foreign Application Priority Data
Oct. 26, 2012 (JP) 2012-236543

(51) Int. Cl. G06F 3/041; G06F 3/023; G06F 3/044; G06F 3/03; G06F 3/0488; G06F 3/0354

(52) U.S. Cl. CPC G06F 3/0416; G06F 3/0412; G06F 3/04886; G06F 3/03545; G06F 3/044; G06F 3/0325; G06F 3/0237; G06F 2203/04101; G06F 2203/04106; G06F 2203/04807

(57) ABSTRACT

Provided is a technology in which even if input is performed in a state where a hand supporting a pen or the like is placed upon a touch panel, erroneous input from the hand can be prevented. A touch panel control unit acquires from a control unit, image data in which a user who will perform input in a detection area of a touch panel was imaged. The touch panel control unit analyzes the image data, identifies an instruction input unit and a hand of a user supporting the input instruction unit, and identifies a reference input location in the detection area. On the basis of a positional relationship of the instruction input unit and the hand of the user, a predicted input area within the detection area, in which input by the input instruction unit may occur, is then set. On the basis of a detection result obtained from the touch panel, the touch panel control unit identifies and outputs an input location in the predicted input area.

### TECHNICAL FIELD

The present invention relates to a coordinate input device and a display device provided with the same, and specifically relates to a technology that prevents erroneous input.

### BACKGROUND ART

Touch panels have become widely used in recent years, particularly in the field of portable information terminals such as smartphone and tablet terminals, due to the fact that input screens can be freely configured via software and touch panels have higher operability and designability compared to devices that use a mechanical switch.

A dedicated system was previously required when using a pen to draw on a smartphone or tablet terminal. However, as touch panel technology has advanced, it has become possible to draw using a normal pen that does not require electricity or the like.

When performing input on a touch panel using a pen or the like, there are instances when input is performed in a state in which a hand holding a pen is placed upon the touch panel. In such cases, both the pen and the hand contact the touch panel, and the location of the pen input may not be correctly recognized. In Japanese Patent Application Laid-Open Publication No. 2002-287889, a technology is disclosed that prevents erroneous input from a hand holding a pen by dividing an input region into a plurality of regions and setting a valid input region, in which coordinate input is valid, and an invalid input region, in which coordinate input is invalid. This technology sets a region, from among the plurality of regions, specified by a user via a pen, as the valid input region, and sets the other regions as invalid input regions. As a result, only coordinates input in the valid input area are considered valid, even if the hand holding the pen contacts an invalid input area. This prevents erroneous input from the hand holding the pen from occurring.

### SUMMARY OF THE INVENTION

The technology described in Japanese Patent Application Laid-Open Publication No. 2002-287889 can prevent erroneous input from a hand holding a pen when the pen contacts the touch panel before the hand holding the pen. However, this technology cannot distinguish between the pen input and the hand input when the hand contacts the touch panel before the pen. As a result, the location where the hand holding the pen contacted the touch panel will be detected.

Furthermore, the technology described in Japanese Patent Application Laid-Open Publication No. 2002-287889 cannot distinguish between the pen input and the hand input when the hand and the pen both contact the valid input area. As a result, the location where the hand holding the pen contacted the touch panel will also be detected.

The present invention provides a technology that can prevent erroneous input from a hand supporting a pen or the like, even if input occurs in a state in which the hand is placed upon a touch panel.

The present coordinate input device includes: a touch panel that is disposed upon a display panel, and that detects contact by an instruction input unit in a detection area; an acquisition unit that acquires image data in which a user who performs input on the touch panel was imaged; an identification unit that identifies a reference input location in the detection area by analyzing the image data acquired by the acquisition unit; a setting unit that sets, on the basis of the reference input location identified by the identification unit and information showing a positional relationship of the instruction input unit and a hand supporting the instruction input unit, a predicted input area within the detection area in which input by the instruction input unit may occur; and an output unit that identifies and outputs an input location in the predicted input area on the basis of a detection result on the touch panel.

This coordinate input device can prevent erroneous input when input is performed in a state in which a hand holding a pen or the like is supported upon a touch panel.

### BRIEF DESCRIPTION OF THE DRAWINGS

FIG. 1 is an exterior perspective view of a display device that includes a coordinate input device according to Embodiment 1.

FIG. 2 is a block diagram that shows an example configuration of a display device according to Embodiment 1.

FIG. 3 is a general configuration diagram of a display panel according to Embodiment 1.

FIG. 4 is a diagram that shows various units that are connected to an active matrix substrate according to Embodiment 1.

FIG. 5 is a diagram that shows an operation area according to Embodiment 1.

FIG. 6 is general configuration diagram of a touch panel according to Embodiment 1.

FIG. 7 is a diagram that shows a functional block of a touch panel control unit and other various related units according to Embodiment 1.

FIG. 8A is a diagram that shows a shape of a hand.

FIG. 8B is a diagram that shows an example of a predicted input area.

FIG. 8C is a diagram that shows an example of a predicted input area.

FIG. 8D is a diagram that shows a predicted input area and a non-input area according to Embodiment 1.

FIG. 9 is an operational flow diagram of a display device according to Embodiment 1.

FIG. 10 is a diagram that shows a functional block of a touch panel control unit and other various related units according to Embodiment 2.

FIG. 11 is an operational flow diagram of a display device according to Embodiment 2.

FIG. 12 is a diagram that shows a detection target area according to Embodiment 2.

FIG. 13A is a diagram that shows an example of an input assistance image according to Embodiment 3.

FIG. 13B is a diagram that shows a nearby state according to Embodiment 3.

FIG. 14 is a diagram that shows a functional block of a touch panel control unit and other various related units according to Embodiment 3.

FIG. 15 is an operational flow diagram of a display device according to Embodiment 3.

FIG. 16 is a diagram that shows a functional block of a touch panel control unit and other related units according to Embodiment 4.

FIG. 17 is a diagram that shows a functional block of a touch panel control unit and other various related units according to Embodiment 6.

FIG. 18 is a diagram that shows a disparity in an input location due to a line of sight of a user according to Embodiment 6.

FIG. 19A is a side view that shows a general configuration of an imaging assistance member in a mobile information terminal according to Modification Example 1.

FIG. 19B is a side view that shows a general configuration of an imaging assistance member in a mobile information terminal according to Modification Example 1.

FIG. 19C is a side view that shows a general configuration of an imaging assistance member in a mobile information terminal according to Modification Example 1.

### DETAILED DESCRIPTION OF EMBODIMENTS

A coordinate input device according to one embodiment of the present invention includes: a touch panel that is disposed on a display panel, the touch panel detecting contact made by an instruction input member in a detection area on the touch panel; an acquisition unit that acquires image data of a user performing input on the touch panel; an identification unit that analyzes the image data from the acquisition unit to identify a reference input location in the detection area on the touch panel; a setting unit that sets a predicted input area where input by the instruction input member may occur within the detection area on the touch panel, the predicted input area being set in accordance with the reference input location identified by the identification unit and in accordance with information representing a positional relationship between the instruction input member and a hand supporting the instruction input member; and an output unit that identifies and outputs an input location on the predicted input area in accordance with a detection result on the touch panel. (Configuration 1).

According to the present configuration, before input occurs on a touch panel via an instruction input unit, a predicted input area is set according to a positional relationship of a hand supporting an instruction input unit and a reference input location. An input location in the predicted input area where input occurred via the instruction input unit is then output. Therefore, even if a user performs input while a hand supporting an instruction input unit such as a pen is placed upon the touch panel, the location where the hand is contacting the touch panel will not be output and the user can perform input in a desired location.

In Configuration 2, the identification unit from Configuration 1 may analyze the image data to identify, as the reference input location, a location in line of sight of a user facing the detection area of the touch panel. When a user performs input, the line of sight of the user usually faces the location where input occurs. According to the present configuration, a predicted input area is set using a location, on a touch panel, of a line of sight of a user as a reference. This means that it will be possible to more appropriately set an area where the user will attempt to input.

In Configuration 3, the identification unit from Configuration 1 may analyze the image data to identify the instruction input member and the hand, and identify a location of the instruction input member in the detection area of the touch panel as the reference input location. When a user performs input by utilizing an instruction input unit such as a pen, a finger, or the like, the user normally brings the instruction input unit close to the location where he/she will attempt to perform input. According to the present configuration, a predicted input area will be set using a location of an instruction input unit as a reference. This means that an area where the user will attempt to input can be more appropriately set.

Configuration 4 may further include a detection control unit that detects, within the detection area on the touch panel, a first area that includes the predicted input area, and a second area excluding the first area where detection is stopped, and the output unit may identify and output an input location in the detection area in accordance with a detection result in the first area on the touch panel.

In Configuration 5, the setting unit from any one of Configurations 1 to 3 may set the detection area excluding the predicted input area as a non-input area, and the output unit may output an input location based on a detection result in the predicted input area on the touch panel and not output an input location based on a detection result in the non-input area on the touch panel. According to the present configuration, an input location that corresponds to the non-input area will not be output. As a result, a user can perform input in a desired location even in a state in which a hand supporting an instruction input unit is placed upon a touch panel.

In Configuration 6, the detection area from Configuration 4 or Configuration 5 may include an operation area for receiving a predetermined instruction, and the setting unit from Configuration 4 or Configuration 5 may set, within the detection area, an area excluding the predicted input area and the operation area as the non-input area. According to the present configuration, input in a predicted input area and an operation area can be reliably detected even if a hand supporting an instruction input unit is placed upon a touch panel.

In Configuration 7, the identification unit from any one of Configurations 1 to 6 may analyze the image data to identify a location of an eye and a location in line of sight of a user facing the detection area, and the output unit may correct the input location identified through a detection result on the touch panel and outputs a corrected input location, the correction being performed in accordance with the location of the eye and the location of the line of sight of the user identified by the identification unit and in accordance with a distance between the display panel and the touch panel. According to the present configuration, erroneous input that occurs due to parallax as a result of the distance between the display panel and the touch panel can be prevented.

A display device according to an embodiment of the present invention has: a coordinate input device according to any one of Configurations 1 to 7; a display panel that displays an image; and a display control unit that displays an image on the display panel in accordance with a detection result output from the coordinate input device (Configuration 8). According to the present configuration, before input occurs on a touch panel, a predicted input area based on a positional relationship of a hand supporting an instruction input unit and a reference input location is set and an input location in the predicted input area is output. As a result, even if a user performs input in a state in which a hand supporting an instruction input unit such as a pen is placed upon a touch panel, a location where the hand is contacting the touch panel will not be output and the user can perform input in a desired location.

In Configuration 9, the identification unit in the coordinate input device from Configuration 8 may analyze the image data and output the reference input location to the display control unit if the instruction input unit is in a nearby state located within a predetermined height from a surface of the touch panel, and the display control unit from the coordinate input device in Configuration 8 may cause to be displayed, in a display region of the display panel, a predetermined input assistance image in a location corresponding to the reference input location received from the coordinate input device. According to the present configuration, a user can be informed of the location where the user is attempting to perform input via an instruction input device.

In Configuration 10, the display control unit from either Configuration 8 or Configuration 9, in a part of the display region corresponding to the predicted input area, may perform display in accordance with a display parameter whereby brightness is reduced below a predetermined display parameter for the display region. According to the present configuration, the glare in a predicted input area can be reduced compared to other areas.

In Configuration 11, the touch panel from either Configuration 8 or Configuration 9 may be formed on a filter that is formed so as to overlap the display panel, and, on the display region corresponding to a part of the filter overlapping the predicted input area, the display control unit may cause a colored first filtered image having a brightness that has been reduced below a predetermined display parameter to be displayed, and, in the rest of the display region, causes a colored second filtered image based on the predetermined display parameter to be displayed.

In Configuration 12, one of any of Configurations 8 to 11 may include an imaging unit that images a user performing input on the touch panel and outputs image data to the coordinate input device.

In Configuration 13, the imaging unit from Configuration 12 may include an imaging assistance member for adjusting an imaging range. According to the present configuration, a user performing input on a touch panel can be more accurately imaged compared to when the present configuration is not included.

Hereafter, the embodiments of the present invention will be explained in further detail while referring to the figures. In order to expedite the explanation, the various figures hereafter referred to are those that show a simplified version of, from among all of the components in the embodiments of the present invention, only the basic components necessary to explain the present invention. Therefore, a display device according to the present invention may include optional components not shown in the various figures referred to in this specification. In

### Embodiment 1

(Overview)

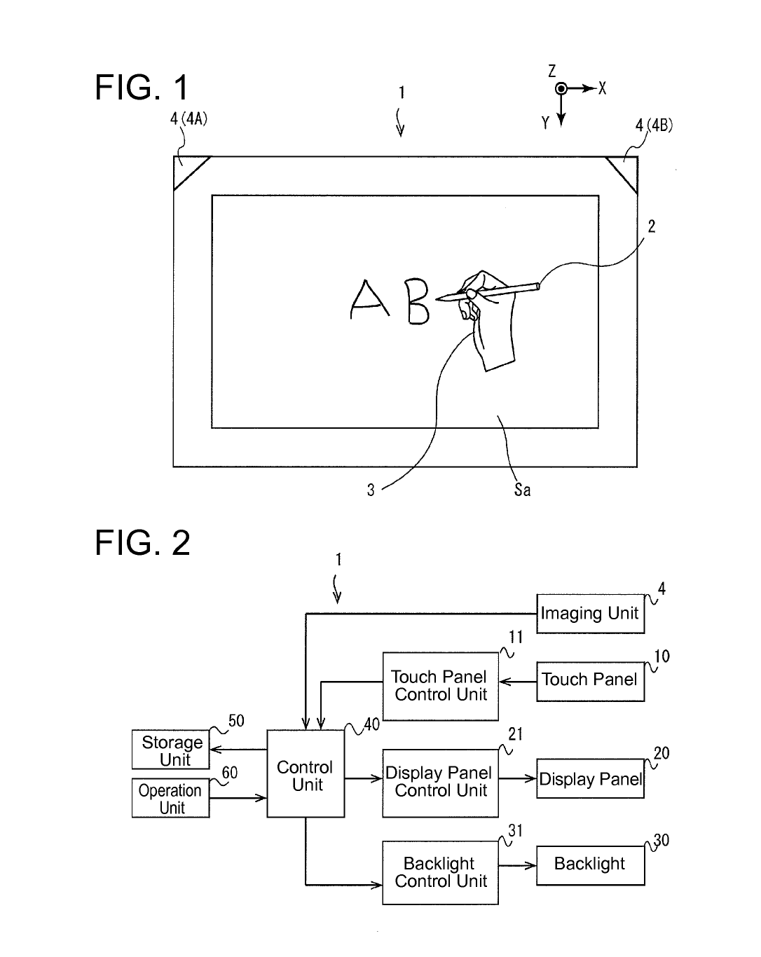

FIG. 1 is a figure that shows the view from above a display device that includes a coordinate input device according to the present embodiment. In the present embodiment, a display device 1 is a display device such as a tablet terminal or the like that has a touch panel, for example. A user performs input on a display surface Sa utilizing a pen 2 in a state in which a portion 3 of a hand supporting the pen 2 (the phrase “portion 3 of the hand holding the pen 2” is hereafter referred to as “the hand 3”) is placed upon the display surface Sa of the display device 1. The pen 2, which is one example of an instruction input unit, is a capacitive stylus pen that does not need electric power or the like. As shown in FIG. 1, an imaging unit 4 (4A, 4B) is installed in the display device 1. The imaging unit 4 images a user performing input on the display surface Sa. The display device 1 performs various types of processing, such as displaying images corresponding to a location where input by the pen 2 occurred on the basis of images imaged by the imaging unit 4. The display device 1 will hereafter be explained in greater detail.

(Configuration)

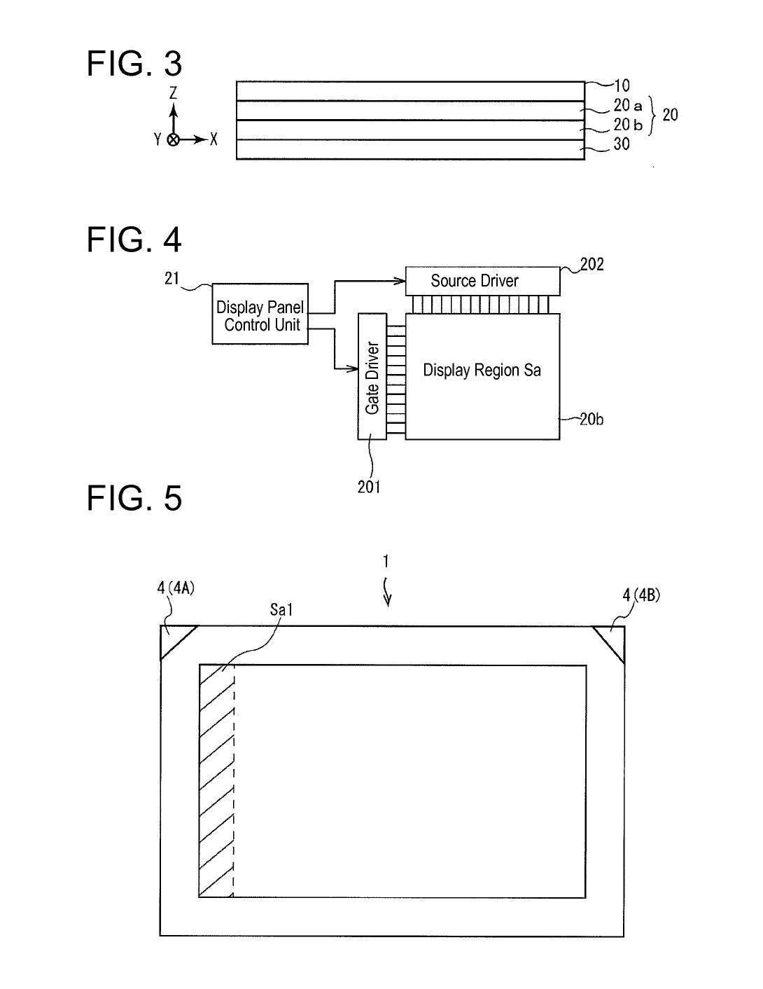

FIG. 2 is a block diagram that shows an example configuration of the display device 1. As shown in FIG. 2, the display device 1 has: a touch panel 10; a touch panel control unit 11 (which is one example of a coordinate input device); a display panel 20; a display panel control unit 21; a backlight 30; a backlight control unit 31; a control unit 40; a storage unit 50; and an operation unit 60. In addition, as shown in FIG. 3, the touch panel 10, the display panel 20, and the backlight 30 in the display device 1 are disposed in that order so as to overlap. These various units will hereafter be explained in more detail.

In the present embodiment, the display panel 20 utilizes a transmissive liquid crystal panel. As shown in FIG. 3, the display panel 20 includes: an active matrix substrate 20b; an opposing substrate 20a; and a liquid crystal layer (not shown) interposed between these substrates. A TFT or thin film transistor (not shown) is formed upon the active matrix substrate 20b, and a pixel electrode (not shown) is formed upon the drain electrode side of the active matrix substrate 20b. A common electrode (not shown) and a color filter (not shown) are formed on the opposing substrate 20a.

As shown in FIG. 4, the active matrix substrate 20b includes a gate driver 201 and a source driver 202, as well as the display panel control unit 21, which drives these drivers. The gate driver 201 is connected to a gate electrode of the TFT via a plurality of gate lines that are connected to the gate electrode of the TFT. The source driver 202 is connected to a source electrode of the TFT via a plurality of source lines that are connected to the source electrode of the TFT. The display panel control unit 21 is connected to these drivers via signal lines that are connected to the gate driver 201 and the source driver 202.

The regions enclosed by the gate lines and the source lines are the pixel regions, and the display region of the display surface Sa includes all of the pixel regions. As shown in FIG. 5, in the present embodiment, a region Sal that is a part of the display surface Sa and is represented by diagonal lines is a region that displays operational menu icons or the like related to an application that is currently running in the display device 1. That is, the operation area Sa1 is an area that receives predetermined instruction operations. The operation area Sa1 is not limited to the region shown in FIG. 5, but may be any predetermined region of the display surface Sa.

The explanation will be continued by returning to FIG. 4. The display panel control unit 21 has a CPU (central processing unit) and memory that includes ROM (read-only memory) and RAM (random access memory). Under the control of the control unit 40, the display panel control unit 21 outputs to the gate driver 201 and the source driver 202 a timing signal that drives the display panel 20, and synchronizes a data signal that represents an image to be displayed with the timing signal and then outputs the data signal to the source driver 202.

The gate driver 201 transmits a scanning signal to the gate lines in response to the timing signal. When the scanning signal is input from the gate lines to the gate electrode, the TFT is driven in response to the scanning signal. The source driver 202 converts the data signal into a voltage signal, and transmits the voltage signal to the source lines by synchronizing the voltage signal with the timing of the output of the scanning signal from the gate driver 201. As a result, liquid crystal molecules in the liquid crystal layer change their orientation in response to the voltage signal and an image corresponding to the data signal is displayed on the display surface Sa by controlling the gradation of each pixel.

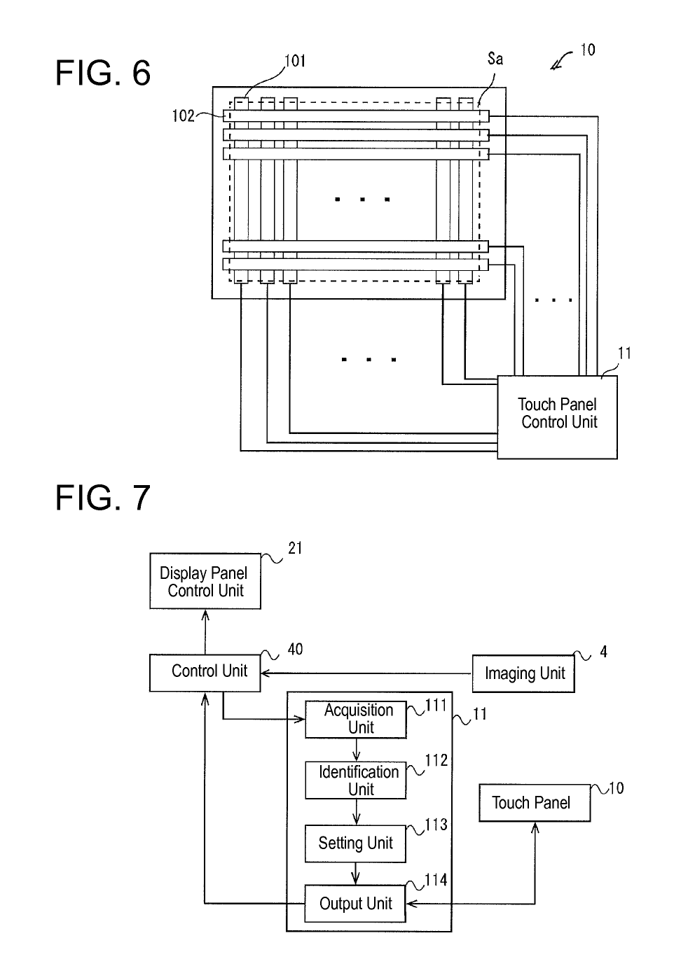

The touch panel 10 and the touch panel control unit 11 will be explained next. FIG. 6 is a figure that illustratively shows the general configuration of the touch panel 10 according to the present embodiment. A projected capacitive touch panel, for example, is used as the touch panel 10. The touch panel 10 is formed so that a plurality of electrodes 101 and a plurality of electrodes 102 intersect on a transparent substrate. The electrodes 101 and the electrodes 102 are made of a transparent conductive film such as ITO (indium tin oxide). In this example, the electrodes 101 are sense electrodes, and these electrodes measure and output the capacitance of a capacitor formed between the electrodes 101 and the electrodes 102 to the touch panel control unit 11. The electrodes 102 are drive electrodes and, under the control of the touch panel control unit 11, charge and discharge the load of the capacitor formed between the electrodes 102 and the electrodes 101. In FIG. 6, the region indicated by the dotted line is the detection area of the touch panel 10, and corresponds to the display region of the display surface Sa.

FIG. 7 is a block diagram that shows a functional block of the touch panel control unit 11 and other various related units. The touch panel control unit 11 has a CPU and memory that includes ROM and RAM. Area setting processing and input location detection processing (both of which will be mentioned later) are performed via the CPU carrying out control programs stored in the ROM.

As shown in FIG. 7, the touch panel control unit 11 has: an acquisition unit 111, an identification unit 112, a setting unit 113, and an output unit 114. The touch panel control unit 11 carries out area setting processing and input location detection processing via these various units. These various units will hereafter be explained in further detail.

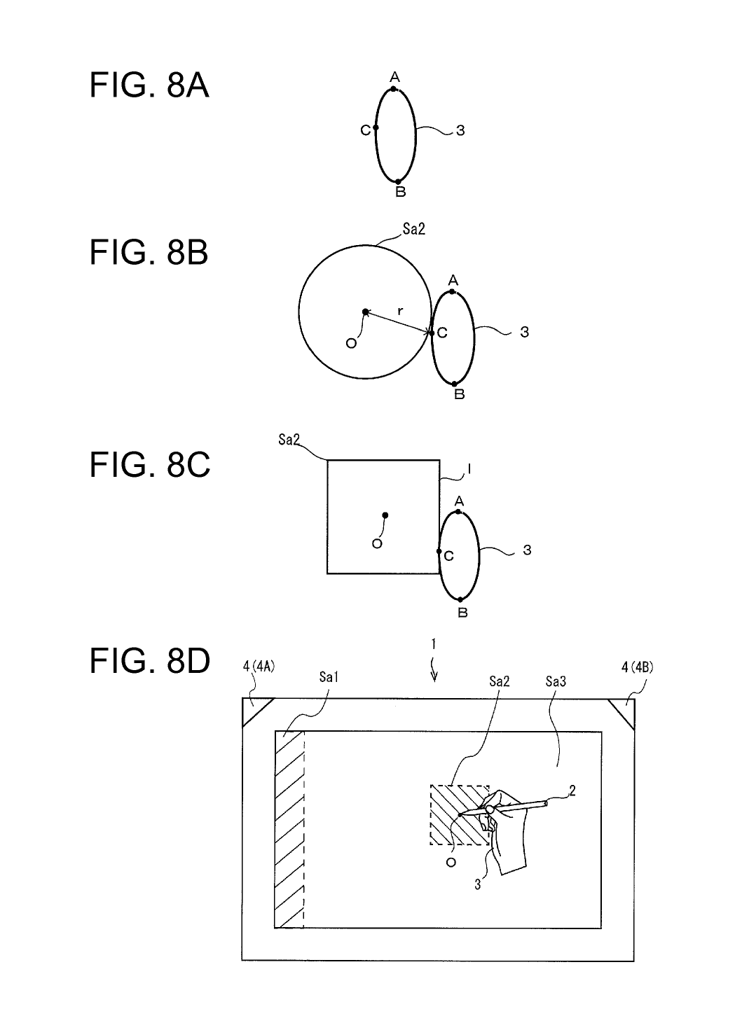

The acquisition unit 111 acquires from the control unit 40 image data that was imaged by the imaging unit 4. The identification unit 112 performs pattern-matching by analyzing the image data acquired by the acquisition unit 111, and identifies a pen 2 and a hand 3 of a user supporting a pen 2. The identification unit 112 then obtains the distance between the imaging unit 4 and the pen 2 and the hand 3 on the basis of the imaging conditions, such as the focal length, of the imaging unit 4. The identification unit 112 calculates the location (absolute coordinates) of the pen 2 and the hand 3 on the display surface Sa by triangulation or the like, on the basis of the distance between the pen 2 and the hand 3 and the imaging unit 4 and the distance between the imaging unit 4A and the imaging unit 4B. As shown in FIG. 1, the hand 3 is the portion of the hand supporting the pen 2 that is placed upon the display surface Sa, and has a roughly oval shape, as shown in FIG. 8A. The identification unit may obtain various coordinates from the oval representing the hand 3 to serve as the location of the hand 3, such as the closest point A on the pinky side, the closest point B on the wrist side, and a point C on the tip of the pen 2 side that lies between points A & B, for example.

The setting unit performs area setting processing on the basis of the coordinates of the hand 3 and the pen 2 that were identified by the identification unit 112. Area setting processing is processing in which a predicted input area and a non-input area are set.

The predicted input area is the area where input by the user may occur, and is determined on the basis of the positional relationship of the pen 2 and the hand 3. Specifically, a coordinate range for the predicted input area is obtained by setting the coordinates of the pen 2 as the reference input location and substituting the coordinates of the pen 2 and the hand 3 into a function in which the coordinates of the pen 2 and the hand 3 are variables. That is, as shown in FIG. 8B, a circle Sa2 in which the coordinates O of the pen are the center and a distance r between the tip of the pen 2 and the hand 3 is a radius, may be set as a predicted input area. In addition, as shown in FIG. 8C, a rectangle Sa2 that has the shape of a square, parallelogram, or the like, in which a line segment I that is a tangent to a location on the hand 3 that is closest to the tip of the pen 2 is one side and the coordinates O of the pen 2 are the center may be set as a predicted input area. In this way, the distance between the tip of the pen 2 and the hand 3 is used as information that indicates the positional relationship of the pen 2 and the hand 3 in the present embodiment.

Meanwhile, the non-input area is an area of the display surface Sa that excludes the predicted input area and the operation area Sal. Area information that indicates the coordinates of the operation area Sa1 is pre-stored in the storage unit 50, which will be mentioned later. The setting unit 113 refers to the area information stored within the storage unit 50 and then sets the non-input area.

FIG. 8D is a figure that shows a predicted input area, a non-input area, and an operation area according to the present embodiment. As shown in FIG. 8D, the predicted input area is a rectangular region Sa2 (hereafter referred to as the predicted input area Sa2) in which a location O of a tip of a pen 2 is set as the reference input area. The non-input area is a region Sa3 (hereafter referred to as the non-input area Sa3) that excludes the operation area Sa1 and the predicted input area Sa2. The setting unit 113 stores in the RAM coordinate data that represents the predicted input area Sa2 every time the predicted input area Sa2 is set.

The explanation will be continued by returning to FIG. 7. The output unit 114 sequentially applies voltage to and drives the drive electrodes 102 of the touch panel 10, sequentially selects the sense electrodes 101, and obtains from the touch panel 10 a detection result that shows the capacitance between the drive electrodes 102 and the sense electrodes 101. If a detection result that is at or above a threshold is obtained, the output unit 114, when the coordinates corresponding to the sense electrodes 101 and the drive electrodes 102 that obtained the detection result are coordinates in the predicted input area Sa2 or the operation area Sa1, outputs the coordinate (absolute coordinates) data to the control unit 40. In addition, the output unit 114 does not output coordinate data that represents those coordinates to the control unit 40 when the coordinates are coordinates within the non-input area Sa3.

The explanation will be continued by returning to FIG. 2. The backlight 30 is disposed in the rearward direction (the opposite direction from the user) of the display panel 20. In the present embodiment, the backlight 30 is a direct backlight and has a plurality of light sources made up of LED (light-emitting diodes). The backlight 30 turns on the various light sources in response to a control signal from the backlight control unit 31.

The backlight control unit 31 has a CPU and memory (ROM and RAM). On the basis of a signal from the control unit 40, the backlight control unit 31 controls the brightness of the backlight 30 by outputting a control signal that represents a voltage corresponding to a brightness to the backlight 30.

The storage unit 50 is a storage medium such as a hard drive. The storage unit 50 stores a variety of different types of data, such as applications programs executed in the display device 1, image data, and area information that represents the operation area Sa1.

The operation unit 60 has a power switch for the display device 1, menu buttons, and the like. The operation unit 60 outputs to the control unit 40 an operation signal that represents operational content that was operated by the user.

The imaging unit 4 (4A, 4B) has a camera such as a CCD camera, for example. The angle of the optical axis of the camera is predetermined so that it contains, at a minimum, the entire display surface Sa in the xy-plane from FIG. 1, and images the user performing input on the display surface Sa. The imaging unit 4 outputs the image data that was imaged by the camera to the control unit 40.

The control unit 40 has a CPU and memory (ROM and RAM). The control unit 40 controls the various units connected to the control unit 40 and performs various types of control processing by means of the CPU implementing control programs stored in the ROM. Examples of control processing include controlling the operation of application programs and displaying images on the display panel 20 via the display panel control unit 21 on the basis of coordinates (absolute coordinates) output from the touch panel control unit 11, for example.

(Operation)

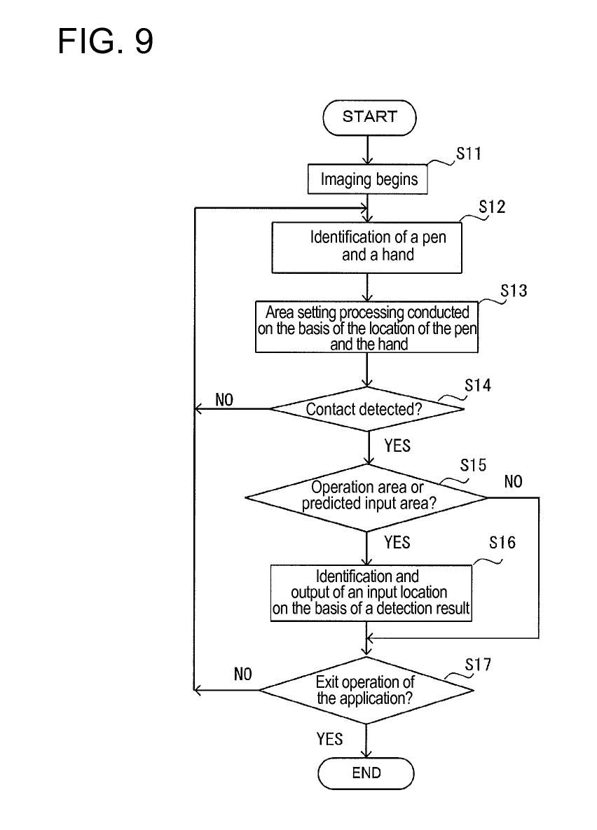

FIG. 9 is an operational flow diagram that shows area setting and input location detection processing in the display device 1 according to the present embodiment. The explanation hereafter will be made under the assumption that the power is on in the display device 1 and an application program such as for drawing, for example, is running.

Under the control of the control unit 40, the imaging unit 4 begins imaging and sequentially outputs the image data to the control unit 40. The control unit 40 outputs the image data output from the imaging unit 4 to the touch panel control unit 11 (Step S11).

When the touch panel control unit 11 acquires the image data output from the control unit 40, the touch panel control unit 11 analyzes the acquired image data and performs processing that identifies the location of the pen 2 and the hand 3 (Step S12). Specifically, the touch panel control unit 11 performs pattern-matching utilizing pattern images of the pen 2 and the hand 3 and identifies the pen 2 and the hand 3 from the images in the image data. The touch panel control unit 11 obtains the distance between the pen tip of the pen 2 and the hand 3 from the imaging unit 4 on the basis of the imaging conditions, such as the focal length, if the pen 2 and the hand 3 were able to be identified. The touch panel control unit 11 then calculates the location of the tip of the pen 2 and the hand 3 on the display surface Sa via triangulation on the basis of the distance of the pen 2 and the hand 3 from the imaging unit 4 and the distance between the imaging unit 4A and the imaging unit 4B.

The touch panel control unit 11 retrieves the area information that represents the operation area from the storage unit 50, and performs area setting processing on the basis of the location of the pen 2 and the hand 3 identified in Step S12 and the various coordinates in the area information (Step S13). Specifically, the touch panel control unit 11 obtains a coordinate range for the predicted input area Sa2 by substituting the coordinates of the pen 2 and the hand 3 into a predetermined arithmetic expression. The touch panel control unit 11 then sets, within the coordinate range of the display surface Sa, the region excluding the predicted input area Sa2 and the operation area Sa1 shown in the area information, as the non-input area Sa3. The touch panel control unit 11 stores the coordinate data representing the predicted input area Sa2 in the RAM.

The touch panel control unit 11 continues the area setting processing from Step S13, drives the touch panel 10, and detects whether or not the pen 2 contacted the display surface Sa (Step S14).

If the capacitance value that is output from the touch panel 10 is below a threshold, the touch panel control unit 11 returns to Step S12 and repeatedly performs the above-mentioned processing (Step S14: NO). If the capacitance value that is output from the touch panel 10 is at or above the threshold (Step S14: YES), the touch panel control unit 11 determines that the pen 2 contacted the touch panel 10 and proceeds to the processing in Step S15.

In Step 15, the touch panel control unit 11 refers to coordinate data that represents the predicted input area Sa (stored in the RAM) and the non-input area Sa3 (contained in the storage unit 50), and, if the coordinates (hereafter referred to as the input location) corresponding to the drive electrodes 102 and the sense electrodes 101 from which the capacitance was output are contained within the operation area Sal or the predicted input area Sa2 (Step S15: YES), outputs the input location to the control unit 40 (Step S16).

If the input location is not contained within the operation area Sal or the predicted input area Sa2, or that is, if the input location is contained within the non-input area Sa3 (Step S15: NO), the touch panel control unit 11 proceeds to the processing in Step S17.

The touch panel control unit 11, via the control unit 40, repeats the processing mentioned in Step S12 and below until the application program that is running ends (Step S17: NO), and when the application program has ended (Step S17: YES), ends the area setting and input location detection processing.

In Embodiment 1 mentioned above, the location of the tip of the pen 2 is set as the reference input location on the basis of image data, and the predicted input area and the non-input area are set on the basis of the positional relationship of the tip of the pen 2 and the hand 3. In addition, even if an input location is detected in the non-input area Sa3 of the touch panel 10, the input location is not output, and only an input location in the predicted input area Sa2 or the operation area Sa1 is output. As a result, even if the hand 3 is placed upon the touch panel 10 before the pen 2 contacts the touch panel 10, the input location of the pen 2 will be appropriately detected, and erroneous input from the hand 3 will be prevented.

### Embodiment 2

In Embodiment 1 mentioned above, an example which detects an input location within the entire display surface Sa, and outputs only an input location within the predicted input area Sa2 or the operation area Sal was explained. In the present embodiment, an example in which drive electrodes 102 disposed in a predicted input area Sa2 are driven and other drive electrodes 102 are stopped from being driven will be explained.

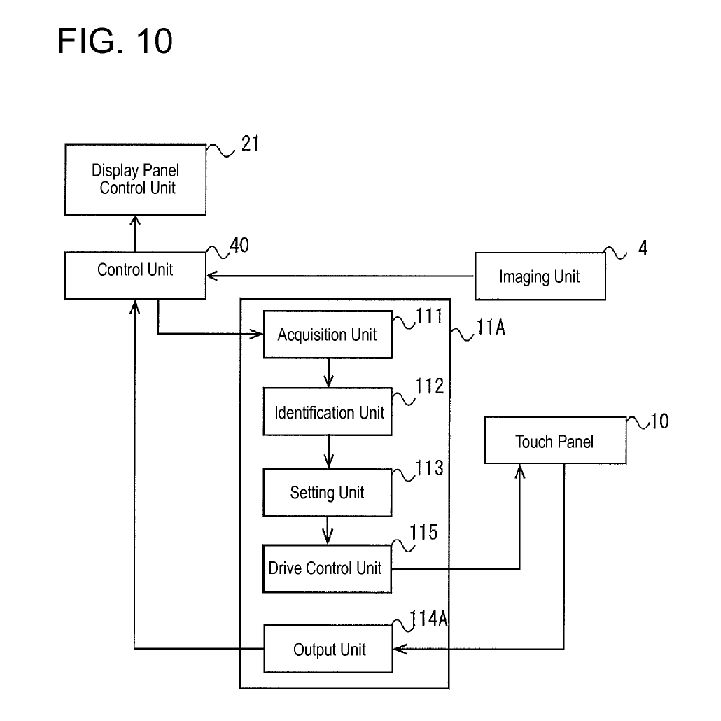

FIG. 10 is a figure that shows a functional block of a touch panel control unit 11 and other various related units according to the present embodiment. As shown in FIG. 10, the touch panel control unit 11A differs from Embodiment 1 in the fact that the touch panel control unit 11A includes a drive control unit 115 (detection control unit) and an output unit 114A.

Every time area setting processing occurs in a setting unit 113, the drive control unit 115 drives the drive electrodes 102 of a touch panel 10 that are disposed in the set predicted input area Sa2 and stops the other drive electrodes 102 from being driven.

The output unit 114A outputs, to a control unit 40, an input location based on a detection result obtained from the touch panel 10 in which driving was controlled via the drive control unit 115.

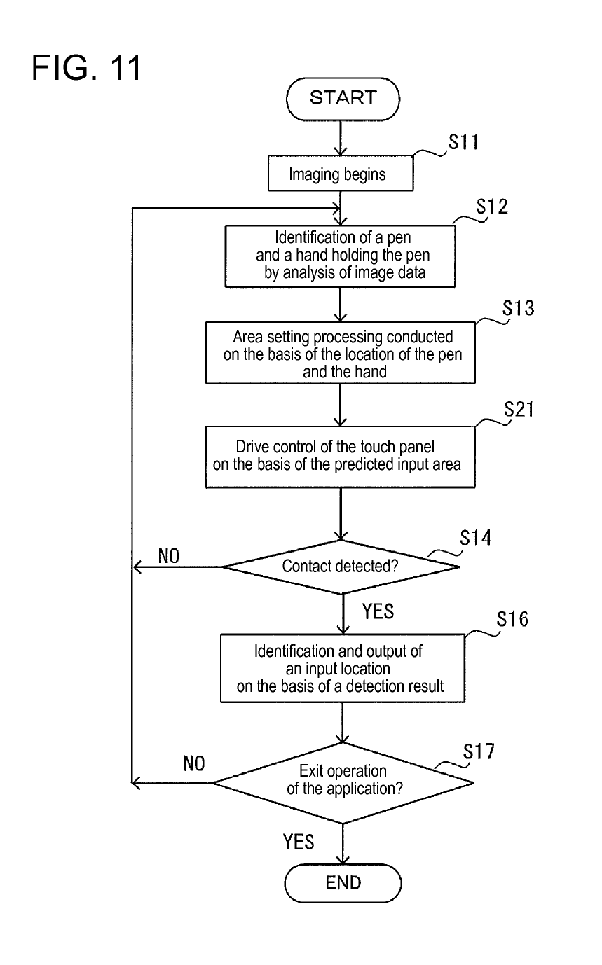

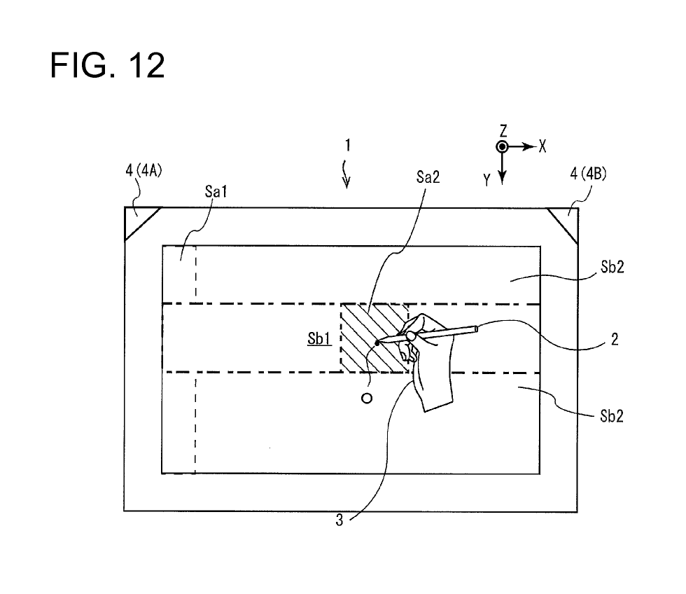

FIG. 11 is an operational flow diagram of area setting processing and input location detection processing in the present embodiment. The processing in Step 11 through Step 13 is the same as in Embodiment 1. The touch panel control unit 11A continues to perform the area setting processing from Step 13, and performs drive control of the touch panel 10 in Step 21. That is, the touch panel control unit 11 drives the drive electrodes 102 of the touch panel 10 that are disposed in the predicted input area Sa2, and stops the other drive electrodes 102 from being driven. In FIG. 12, the drive electrodes 102 (refer to FIG. 6) are disposed in the x-axis direction. Therefore, as shown in FIG. 12, the drive electrodes 102 that will be driven are disposed in a first area Sb1 that is enclosed by dotted lines and which includes the predicted input area Sa. Also, in FIG. 12, the drive electrodes 102 that are stopped from being driven are disposed in a second area Sb2 that excludes the first area Sb1.

The touch panel control unit 11A, whenever performing area setting processing, controls the drive of the drive electrodes 102 from Step 21, and detects whether or not a pen 2 has contacted the predicted input area Sa2 on the basis of a detection result output from the touch panel 10 (Step S14).

In Step S14, if the detection result is equal to or exceeds a threshold (Step S14: YES), the touch panel control unit 11A outputs to the control unit 40 an input area corresponding to the detection result (Step S16).

In Embodiment 2 mentioned above, only the drive electrodes 102 disposed in the predicted input area Sa2 are driven, and the other drive electrodes 102 are stopped. As a result, if the operation area Sa1 is set as shown in FIG. 12, a portion of the operation area Sa1 will not be detected, and a portion of the non-input area Sa3 will be detected. However, when compared to instances in which detection is performed over the entire area, power consumption can be reduced, and since only the drive electrodes 102 disposed in the predicted input area Sa2 are driven, the detection rate of the input location can be increased.

### Embodiment 3

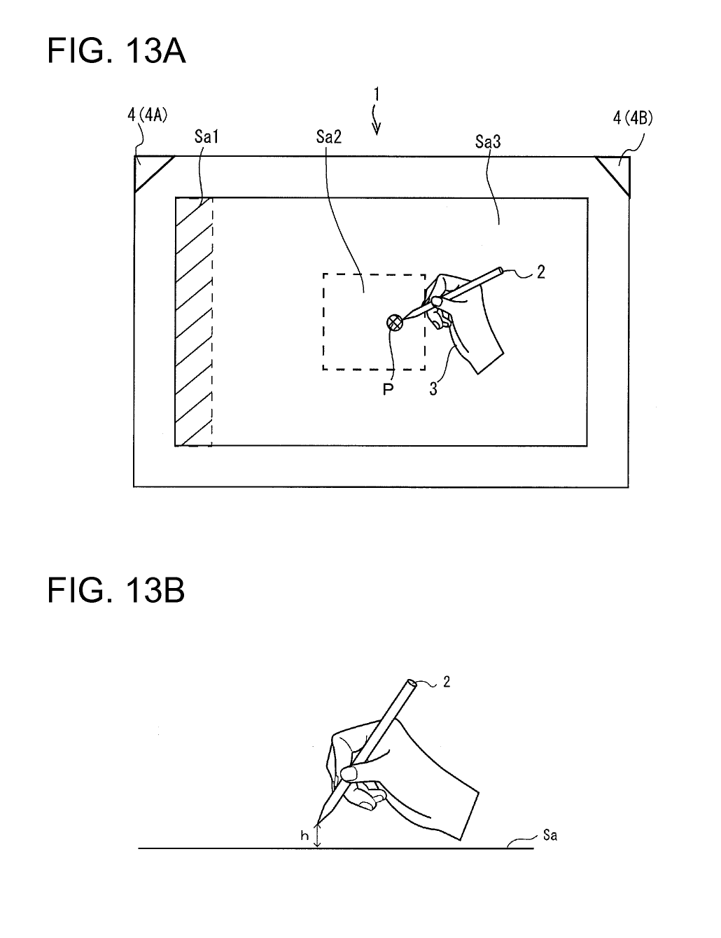

In the present embodiment, an example in which an image (hereafter referred to as an input assistance image) that shows a location of a tip of a pen 2 is caused to be displayed in a predicted input area Sa2, which is set by area setting processing according to the above-mentioned Embodiment 1, will be explained. FIG. 13A is a figure that shows a state in which an input assistance image P is displayed in the predicted input area Sa2. In the present embodiment, as shown in FIG. 13B, when the distance between the tip of the pen 2 and a display surface Sa is in a state (hereafter referred to as a nearby state) of being less than or equal to a predetermined distance h, the input assistance image P, which shows the location of the tip of the pen 2, is displayed.

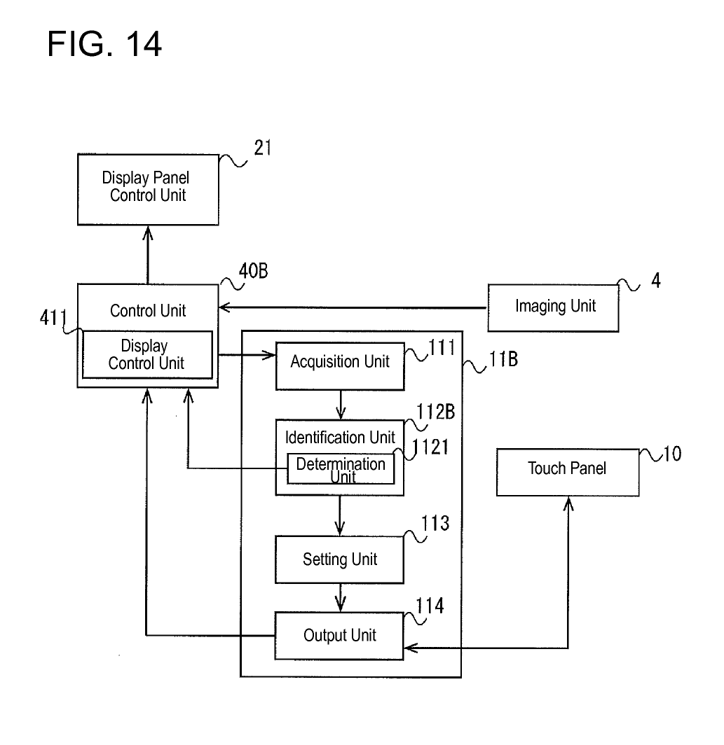

FIG. 14 is a block diagram that shows a functional block of a touch panel control unit 11 and other various related units according to the present embodiment. As shown in FIG. 14, in the touch panel control unit 11B, an identification unit 112B has a determination unit 1121. In addition, a control unit 40B has a display control unit 411. Hereafter, the processing of the above-mentioned various units that differ from Embodiment 1 will be explained.

As in Embodiment 1, the identification unit 112B identifies the location of the pen 2 and a hand 3 from image data. The determination unit 1121, on the basis of the identified location of the pen 2, determines that the tip of the pen 2 is in a nearby state with respect to the display surface Sa if the distance between the tip of the pen 2 and the display surface Sa is less than or equal to a predetermined distance h. If the tip of the pen 2 is in a nearby state with respect to the display surface Sa, the determination unit 1121 then outputs to the control unit 40A location information that represents the reference input location that is identified by the identification unit 112A.

In the control unit 40B, when the display control unit 411 acquires location information, which is output from the determination unit 1121, of the pen 2, the display control unit 411 outputs to the display panel 20 instruction to display the input assistance image P in the location of the display panel 20 that is represented by the location information. The display panel 20 displays the input assistance image P in response to the instruction from the display control unit 411. In the present embodiment, there is an example in which an input assistance image P that has a circular shape is displayed, but the input assistance image P may be any desired image, such as an icon or an arrow image.

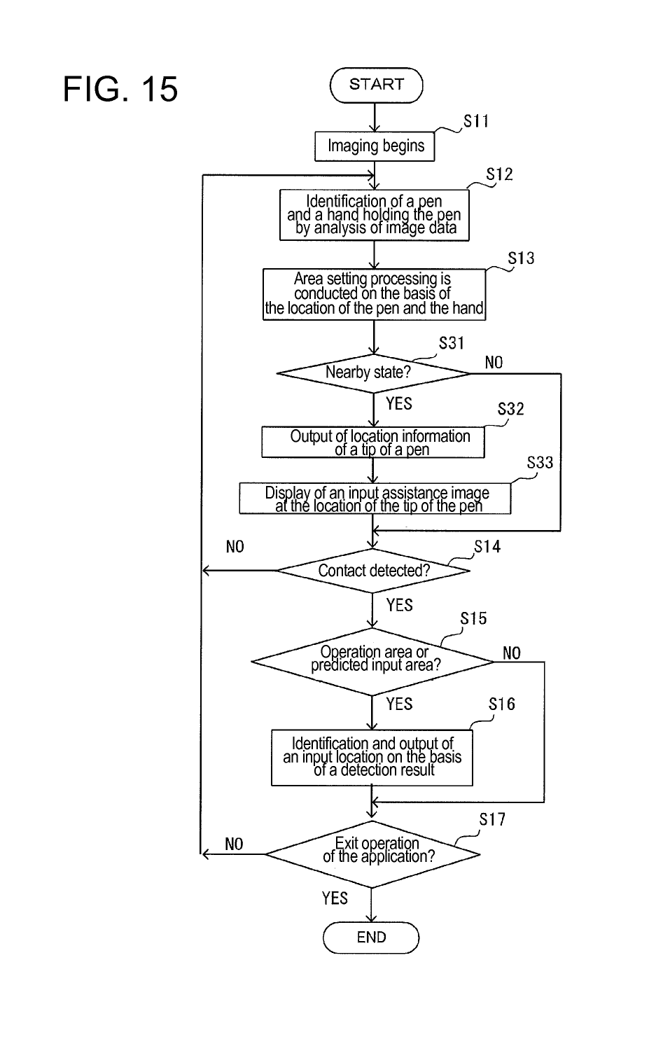

Next, the operation of a display device according to the present embodiment will be explained using FIG. 15. Explanation of processing that is identical to that in the above-mentioned Embodiment 1 will be omitted. The touch panel control unit 11B will continue to perform the area setting processing from Step S13, and in Step S31, will determine whether or not the tip of the pen 2 is in a nearby state with respect to the display surface Sa on the basis of the location of the pen 2 that was identified in Step S12 (Step S31).

If the distance between the location of the tip of the pen 2 and the display surface Sa is less than or equal to a predetermined distance h (Step S31: YES), the touch panel control unit 11B will determine that this is a nearby state and proceed to the processing of Step S32. Meanwhile, if the distance between the location of the tip of the pen 2 and the display surface Sa is not less than or equal to the predetermined distance h (Step S31: NO), the touch panel control unit 11B will determine that this is not a nearby state and proceed to the processing of Step S14.

In Step S32, the touch panel control unit 11B outputs to the control unit 40A location information that represents the location of the pen 2, which is near the display surface Sa, or in other words, the reference input location (Step S32).

When the location information is output from the touch panel control unit 11B, the control unit 40B outputs to the display panel control unit 21 an instruction to display the input assistance image P in the display region of the display panel 20 that is indicated in the location information. The display panel control unit 21, on the display panel 20, displays the input assistance image P in the display region that corresponds to the instructed location information (Step S33).

In Embodiment 3 mentioned above, when the tip of the pen 2 is in a nearby state with respect to the display surface Sa, the input assistance image P is displayed in the location of the tip of the pen 2 in the predicted input area Sa2. Erroneous input can be reduced because the user can more easily move the tip of the pen 2 to a desired location as a result of the input assistance image P being displayed.

### Embodiment 4

In the present embodiment, a display in a predicted input area set according to Embodiments 1 to 3 mentioned above is displayed under display conditions in which the glare is reduced below that of other areas. Specifically, the brightness of light sources of a backlight 30 that include a predicted input area Sa will be controlled so as be lower than that of other light sources, for example.

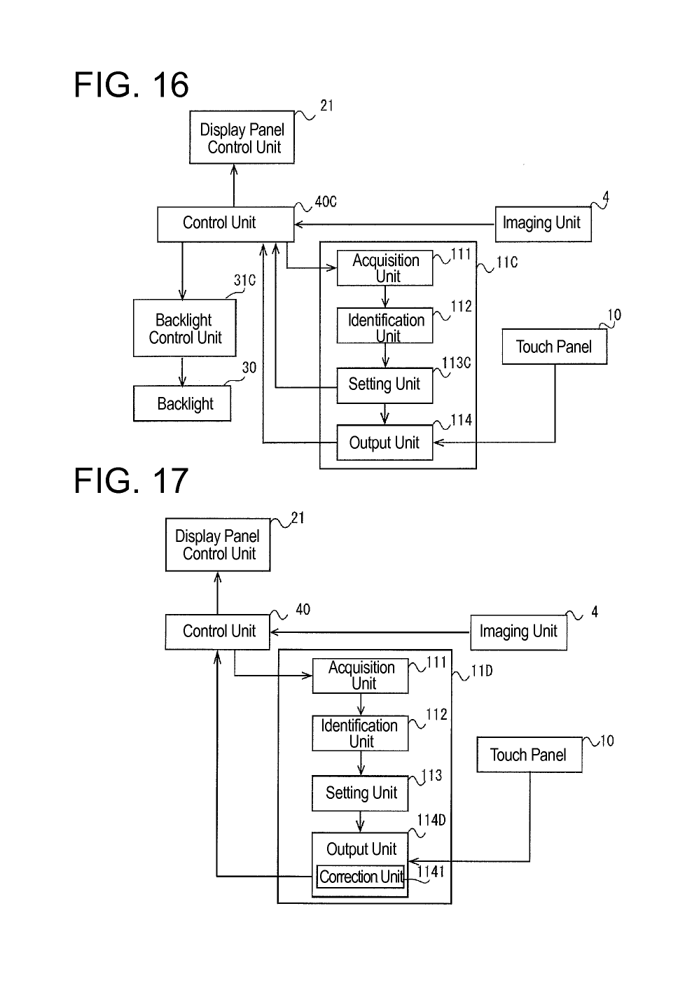

FIG. 16 is a block diagram that shows a functional block of a touch panel control unit and other various related units according to the present embodiment. As shown in FIG. 16, in a touch panel control unit 11C, a setting unit 113C, in addition to performing area setting processing identical to that in Embodiment 1, outputs to a control unit 40C coordinate information that indicates the coordinates of a predicted input area Sa2 every time the predicted input area Sa2 is set.

The control unit 40C outputs to a backlight control unit 31C the coordinate information that was output from the setting unit 113C of the touch panel control unit 11C.

The backlight control unit 31C stores in the ROM, as arrangement information of the various light sources (not shown) included in the backlight 30, the absolute coordinates in a display region that correspond to the location of the various light sources, and the identification information of the light sources. When the coordinate information is output from the control unit 40C, the backlight control unit 31C refers to the arrangement information of the various light sources, and outputs to the light sources that correspond to that coordinate information a control signal that indicates a brightness (second brightness) that is smaller than a brightness (first brightness) that was preset for all of the light sources. The backlight control unit 31C also outputs a control signal that indicates the first brightness to the light sources that correspond to coordinates other than the coordinates in the coordinate information output from the control unit 40C.

In the above-mentioned Embodiment 4, the backlight 30 is controlled so that the brightness of the predicted input area Sa2 is lower than the brightness of the other areas. As a result, the brightness of the light emitted from the screen towards the user who is performing input on the touch panel 10 is reduced, and visibility can be improved.

### Embodiment 5

In Embodiment 1 mentioned above, an example in which a predicted input area is set by setting a location of the tip of a pen 2 as a reference input area is explained. In the present embodiment, an example in which a predicted input area is set by setting a location of a line of sight of a user who is facing a display surface Sa as a reference input area is explained.

Specifically, in an identification unit 112 of a touch panel control unit 11, image data that was acquired by an acquisition unit 111 is analyzed, and the location of an eye of a user is identified using pattern-matching. The identification unit 112 then obtains the coordinates of the center of the eye via the curvature of the eyeball and obtains the coordinates of the center of the pupil by identifying a pupil portion of an eyeball region. The identification unit 112 obtains a vector from the center of the eyeball to the center of the pupil as a line of sight vector, and identifies a location (hereafter referred to as the line of sight coordinates) of the line of sight facing the display surface Sa on the basis of the location of the eye of the user and the line of sight vector.

A setting unit 113 sets the line of sight coordinates identified by the identification unit 112 as a reference input location, and, as in Embodiment 1, sets a predicted input area Sa2 on the basis of a positional relationship of a pen 2 and a hand 3 identified by the identification unit 112. In addition, the setting unit 113 sets as a non-input area Sa3 an area within the display surface Sa that excludes the predicted input area Sa2 and an operation area Sa1.

In Embodiment 5 mentioned above, a predicted input area Sa2 is set by setting a location of a line of sight of a user facing a display surface Sa as a reference input location. Normally when input is performed, the input is performed along the line of sight. As a result, as in Embodiment 1, the predicted input area where the user is attempting to input can be appropriately set, and the input location of the pen 2 can be detected even if the hand 3 supporting the pen 2 is placed upon the display surface Sa.

### Embodiment 6

In the present embodiment, an example which corrects and outputs coordinates that represent a detected contact location in a predicted input area that was set via the above-mentioned area setting processing is explained. FIG. 17 is a figure that shows a functional block of a touch panel control unit and other various related units according to the present embodiment. As shown in FIG. 17, a touch panel control unit 11D includes a correction unit 1141 in an output unit 114D.

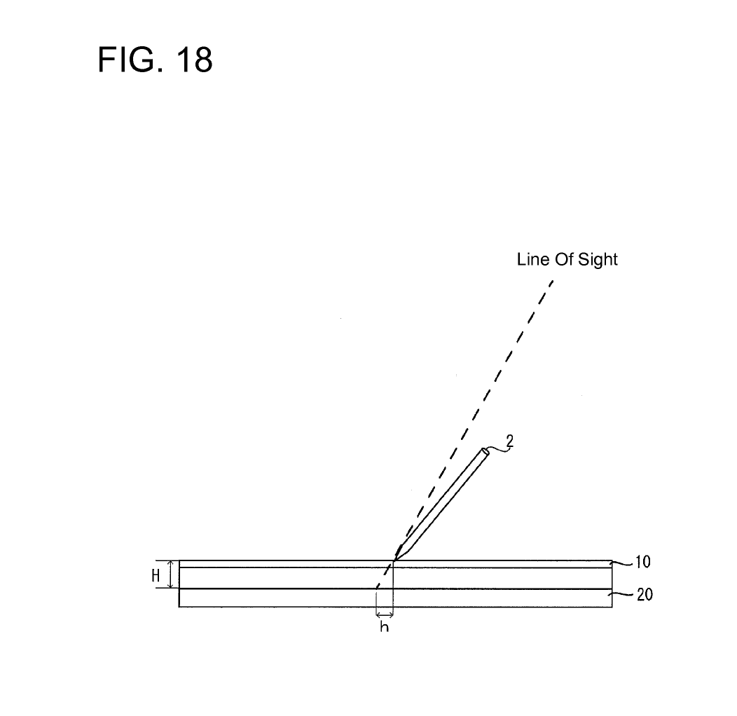

As shown in FIG. 18, when a user is looking at a screen in a direction that is diagonal with respect to a display surface Sa, a parallax h occurs due to a distance H between a touch panel 10 and a display panel 20, and there is thus a disparity between the location at which the user is actually looking, or that is, the location where the user wants to input, and the location in which the tip of the pen 2 actually contacted the touch panel 10.

The correction unit 1141 utilizes image data acquired by an acquisition unit 111, and corrects the input location detected by the output unit 114D. Specifically, the correction unit 1141 identifies the location of an eye of the user by utilizing the image data and performing pattern matching, and also obtains a line of sight vector of the user. The line of sight vector, as in Embodiment 5 mentioned above, is the vector moving from the center of the eye to the center of the pupil. The parallax h is then calculated on the basis of the location of the eye of the user and the line of sight vector, and the distance H between the touch panel 10 and the display panel 20. The correction unit 1141 utilizes the calculated parallax and corrects the input location that is detected by the output unit 114D, and outputs the corrected input location to the control unit 40.

In this way, in Embodiment 6, it is possible to approximate the location where the user actually wants to input because the input location is corrected by calculating the parallax from the image data. As a result, input accuracy can be improved compared to instances in which the input location is not corrected. Furthermore, in Embodiment 5, when correcting the input location as in the present embodiment, the parallax h may be calculated in the correction unit 1141 by utilizing the location of the eye and the line of sight vector obtained by the identification unit 112 because the location of the eye of the user and the line of sight vector are continually obtained by the identification unit 112.

### Modification Examples

Embodiments of the present invention were explained above, but the present invention is not limited to only the above-mentioned embodiments. Various modification examples and examples in which various modification examples have been combined are mentioned below, and these are also included within the scope of the present invention.

(1) There are no particular restrictions to the location or number of cameras utilized in the imaging unit 4 in Embodiments 1 to 6 mentioned above.

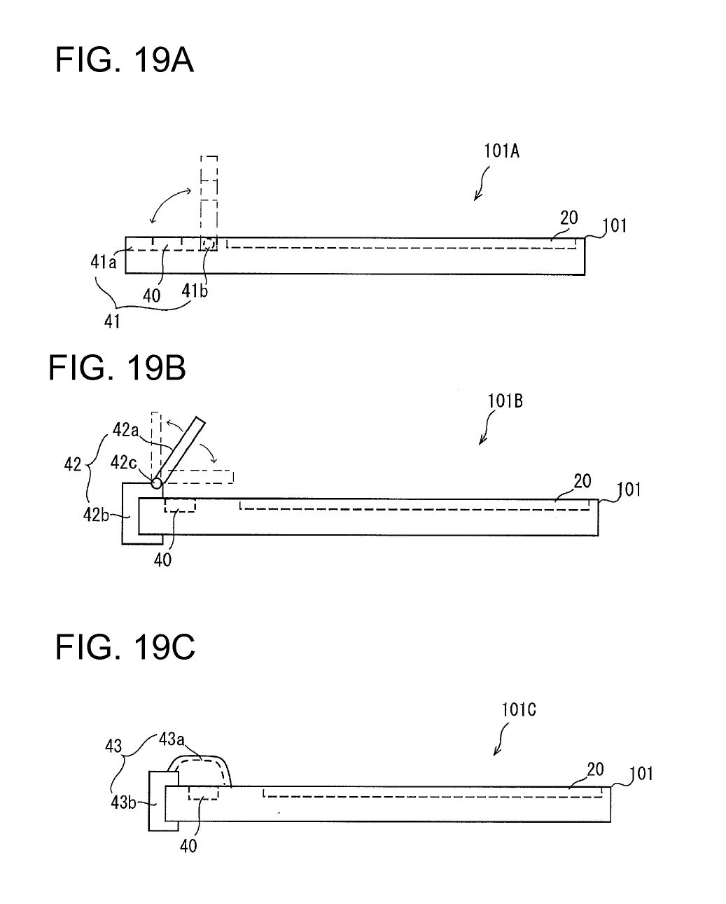

In addition, in Embodiments 1 to 6 mentioned above, there were examples in which the imaging unit 4 was attached to the outside of the display device; however, a camera that is equipped in a portable information terminal may be utilized when the display device is a portable information terminal such as a mobile telephone or the like, for example. In such instances, an imaging unit 41, as shown in FIG. 19A, has a camera 40, a housing member 41a that houses the camera 40, and a rotary member 41b that connects the housing member 41a and a portable information terminal 101A, for example. In this example, the housing member 41a and the rotary member 41b are examples of imaging assistance members. As shown by the arrow in FIG. 19A, the housing member 41a is configured so as to, from a state (a state which is approximately level with respect to the upper surface of the casing 101) of being housed inside the casing 101 of the portable information terminal 101A, only incline with respect to the upper surface of a casing 101 at an angle corresponding to the rotational angle of the rotary member 41b. That is, the housing member 41a is configured so that the angle of the optical axis of the camera 40 housed in the housing member 41a changes according to the angle of the housing member 41a. As a result of the housing member 41a being configured in this manner, the imaging range can be adjusted by rotating the housing member 41a of the camera 40 via user operation, so that a display surface Sa of a display panel 20 and a user will be imaged.

In addition, as shown in FIG. 19B, an imaging assistance member 42 having a detachable panel 42a on the camera 40 portion of the portable information terminal 101B may be provided, for example. The imaging assistance member 42 has the panel 42a, a clip 42b, and a rotary member 42c such as a hinge. The panel 42a and the clip 42b are connected via the rotary member 42c, and, as shown by the arrow in FIG. 19B, are configured so that the inclination of the panel 42a changes in accordance with the amount of rotation of the rotary member 42c. By providing the panel 42a in such a way, the photographic range of the camera 40 housed inside the casing 101 of the portable information terminal 101B can be increased. In this example, the invention is configured so that the inclination of the panel 42a changes, but since the photographic range of the camera 40 will change according to the angle of the panel 42a, the panel may be affixed to the clip 42b at a prescribed angle. By fixing the inclination of the panel 42a beforehand so that the display surface Sa and the user who will input are imaged, it is possible to more reliably photograph the display surface Sa and the user.

In addition, as shown in FIG. 19C, the invention may be configured so that a detachable imaging assistance member 43 that has a lens 43a covers the camera 40 portion of a portable information unit 101C, for example. The imaging assistance member 43 is configured so as to connect the lens 43a and a clip 43b. In instances when the lens 43a covers the lens portion of the camera 40, the lens 43a is a wide-angle lens in which the image angle and the focal length are set so that, at a minimum, the display surface of a display panel 20 and a user who will perform input are imaged by the camera 40. By having the lens 43a cover the lens portion of the camera 40 in this way, the photographic range of the camera 40 can be increased, and the display surface Sa and the user may be more reliably imaged.

Furthermore, the touch panel control unit 11 may adjust the location of the tip of the pen 2 that was identified, on the basis of the difference between the location of the display surface Sa that was imaged by the camera 40 in a state in which the imaging assistance members 41, 42, 43 were provided as above and the predetermined location of the display surface Sa, and may perform calibration processing that adjusts an arithmetic expression for identifying the location of the tip of the pen 2, for example.

(2) In Embodiments 1 to 6 mentioned above, an example which set as a non-input area an area, within an entire display surface Sa, that excluded an operation area and a predicted input area was explained, but the invention may be configured as follows. The invention may be configured so that, irrespective of the setting of the operation area, an area within the entire area that excludes the predicted input area is set as the non-input area, for example. In addition, the area where the hand 3 is placed may be set as the non-input area and the area within the entire area that excludes the non-input area may be set as the predicted input area, for example.

(3) In Embodiments 1 to 6 mentioned above, an example that sets a predicted input area by utilizing the distance between a hand 3 and a pen 2 identified from image data is explained, but the invention may also be configured as below. A range for the predicted input area may be set by using a default value, in which the distance between the pen 2 and the hand 3 was predetermined, as information that indicates the positional relationship of the pen 2 and the hand 3, for example. Since the size of a hand of a user differs between a child and an adult, the positional relationship of the pen 2 and the hand 3 will also differ, for example. Because of this, the invention may be configured so that a plurality of predetermined default values are stored within the storage unit 50 and the default value changes on the basis of a user operation or image data.

(4) In Embodiment 1 mentioned above, a predicted input area is set by setting a location of an imaged tip of a pen 2 as a reference input location; however, the invention may also be configured as follows. A touch panel control unit 11, in a setting unit 113, sets a predicted input area (hereafter referred to as a first predicted input area) in which a location of the tip of a pen 2 is set as a reference input location and, as in Embodiment 5, a predicted input area (hereafter referred to as a second predicted input area) in which a location of a line of sight of a user facing a display surface Sa is set as a reference input location, for example. The setting unit 113 may then be configured so as to set as a predicted input area an area which combines the first predicted input area and the second predicted input area. By configuring the invention in this way, the area where input from a user may occur can be more appropriately set when compared to Embodiments 1 to 5.

(5) In Embodiment 4 mentioned above, an example which decreased the glare in a predicted input area that was set in Embodiment 1 was explained; however, the same control may be performed in Embodiments 2, 3, and 4 to 6. Furthermore, in Embodiment 4 mentioned above, an example which reduced the brightness in a predicted input area by controlling the brightness of a backlight 30 in the predicted input area was explained; however, the invention may be configured so as to reduce the brightness of the predicted input area as follows.

A control unit 40 may be configured so as to, in a display panel control unit 21, reduce the gradation of an image in the predicted input area below a predetermined gradation, thereby displaying the predicted input area as darker than other areas, for example. In addition, in the display panel control unit 21, when displaying in a display panel 20 image data that is displayed in the predicted input area, the image data may be displayed on the display panel 20 by reducing the applied voltage, which corresponds to the image data, to the display panel 20.

(6) In Embodiment 4 mentioned above, glare is reduced by controlling the brightness of light sources of a backlight 30 that includes a predicted input area Sa so as to be lower than that of other light sources; however, the following examples may be used as well. A touch panel 10 is formed upon a filter disposed so as to overlap with a display surface Sa, for example. In a display region, which corresponds to the predicted input area Sa2, in the filtered region portion of the display surface Sa, an image in which the glare is reduced, for example a halftone image (a first filtered image), is displayed. The invention may also be configured so that, in another region, an image (a second filtered image) of a predetermined color, for example white, is displayed.

(7) In Embodiment 2 mentioned above, the invention may be configured so that a detection area in a touch panel 10 may be made up of a plurality of areas, and may be configured so as to perform drive control in each area via a drive control unit 115. In such instances, the invention may be configured so as to include a plurality of touch panel control units 11A corresponding to the plurality of areas, and, via the drive control units 115 of the touch panel control units 11A corresponding to the areas not included in the predicted input area Sa, turn off those areas.

(8) In Embodiment 3 mentioned above, an example which displays an input assistance image in a predicted input area set in Embodiment 1 was explained; however, the input assistance image may be displayed in Embodiments 2 and 4 to 6 as well.

(9) In Embodiments 1 to 6 mentioned above, an example which utilizes a pen 2 as an instruction input unit was explained; however, the invention may also be configured so that a finger of a user may be utilized as the instruction input unit. In such instances, the touch panel control unit 11 identifies a fingertip of the user, instead of a pen 2, from image data, and sets a predicted input area using the location of the fingertip as a reference input location.

(10) In Embodiments 1 to 6 mentioned above, an instance in which there was a single instruction input unit was explained; however, a plurality of instruction input units may be utilized. In this instance, the touch panel control unit identifies a reference input location for each instruction input unit, and performs area setting processing for each instruction input unit.

(11) In Embodiments 1 through 6 mentioned above, an example of a capacitive touch panel was explained; however, the touch panel may be an optical touch panel, an ultrasonic touch panel, or the like, for example.

(12) In Embodiments 1 to 6 mentioned above, the display panel 20 may be an organic electroluminescent (EL) panel, an LED panel, or a PDP (plasma display panel).

(13) The display device in Embodiments 1 to 6 mentioned above can be used in an electronic whiteboard, digital signage, or the like, for example.

### INDUSTRIAL APPLICABILITY

The present invention is industrial applicable as a display device that includes a touch panel.

1. A coordinate input device, comprising:
a touch panel configured to be disposed on a display panel, the touch panel detecting contact made by an instruction input member in a detection area on the touch panel;
an acquisition unit that acquires image data of a user performing input on said touch panel;
an identification unit that analyzes said image data from the acquisition unit to identify a reference input location in said detection area on the touch panel;
a setting unit that sets a predicted input area where input by said instruction input member may occur within said detection area on the touch panel, said predicted input area being set in accordance with said reference input location identified by said identification unit and in accordance with information representing a positional relationship between said instruction input member and a hand supporting said instruction input member; and
an output unit that identifies and outputs an input location on said predicted input area in accordance with a detection result on said touch panel.

2. The coordinate input device according to claim 1, wherein the identification unit analyzes the image data to identify, as said reference input location, a location in the detection area at which line of sight of a user facing said detection area intersects the touch panel.

3. The coordinate input device according to claim 1, wherein said identification unit analyzes the image data to identify the instruction input member and the hand, and identifies a location of a tip of said instruction input member projected onto said detection area of the touch panel as the reference input location.

4. The coordinate input device according to claim 1, further comprising:
a detection control unit that detects, within said detection area on the touch panel, a first area that includes said predicted input area, and a second area excluding said first area where detection is stopped,
wherein the output unit identifies and outputs an input location in said detection area in accordance with a detection result in said first area on the touch panel.

5. The coordinate input device according to claim 1,
wherein said setting unit sets said detection area excluding said predicted input area as a non-input area, and
wherein said output unit outputs an input location based on a detection result in said predicted input area on the touch panel and does not output an input location based on a detection result in said non-input area on the touch panel.

6. The coordinate input device according to claim 4,
wherein said detection area includes an operation area for receiving a predetermined instruction, and
wherein said setting unit sets, within said detection area, an area excluding said predicted input area and said operation area as the non-input area.

7. The coordinate input device according to claim 1,
wherein said identification unit analyzes the image data to identify a location of an eye and a location in line of sight of a user facing the detection area, and
wherein said output unit corrects the input location identified through a detection result on the touch panel and outputs a corrected input location, said correction being performed in accordance with the location of the eye and the location of the line of sight of said user identified by said identification unit and in accordance with a distance between said display panel and said touch panel.

8. A display device comprising:
the coordinate input device according to claim 1;
a display panel that displays an image; and
a display control unit that displays an image on said display panel in accordance with a detection result output from said coordinate input device.

9. The display device according to claim 8,
wherein, in said coordinate input device, the identification unit analyzes the image data, and outputs the reference input location to the display control unit if the instruction input unit is in a nearby state located within a predetermined height from a surface of the touch panel, and
wherein said display control unit causes to be displayed, in a display region of said display panel, a predetermined input assistance image in a location corresponding to the reference input location received from said coordinate input device.

10. The display device according to claim 8, wherein said display control unit, in a part of the display region corresponding to the predicted input area, performs display in accordance with a display parameter whereby brightness is reduced below a predetermined display parameter for said display region.

11. The display device according to claim 8,
wherein said touch panel is formed on a filter that is formed so as to overlap said display panel, and
wherein, on the display region corresponding to a part of the filter overlapping the predicted input area, said display control unit causes a colored first filtered image having a brightness that has been reduced below a predetermined display parameter to be displayed, and, in the rest of the display region, causes a colored second filtered image based on said predetermined display parameter to be displayed.

12. The display device according to claim 8, further comprising:
an imaging unit that images a user performing input on said touch panel and outputs image data to said coordinate input device.

13. The display device according to claim 12, wherein said imaging unit comprises an imaging assistance member for adjusting an imaging range.
